(19) United States
(12) Patent Application Publication
(10) Pub. No.: US 2019/0128245 A1
(43) Pub. Date: May 2, 2019

(54) COMPRESSOR

(71) Applicant: ACTIVE TOOLS INTERNATIONAL (HK) LTD., Hong Kong (CN)

(72) Inventor: Ying Chi David HONG, Hong Kong (CN)

(73) Assignee: ACTIVE TOOLS INTERNATIONAL (HK) LTD., Hong Kong (CN)

(21) Appl. No.: 16/099,416

(22) PCT Filed: May 6, 2016
(86) PCT No.: PCT/CN2016/081238

§ 371 Date: Nov. 6, 2018

(51) Int. Cl. F04B 9/02; B60C 19/12; F04B 15/02; F04B 17/03; F04B 17/06; F04B 35/01; F04B 35/04; F04B 35/06; B29C 73/16

(52) U.S. Cl. CPC F04B 9/02; B60C 19/12; F04B 15/02; F04B 17/03; B29C 73/166; F04B 35/01; F04B 35/04; F04B 35/06; F04B 17/06

(57) ABSTRACT

A compressor for discharging tire sealant or pumping tire including: a body having an inlet for introducing the tire sealant or air and an outlet for discharging the tire sealant; an electric motor which is fixed within the body; a piston for compressing the tire sealant or air; a drive mechanism for transferring the output of the electrical motor into reciprocation movement of the piston, the drive mechanism includes a drive rod having bidirectional thread. And a system of compressor for discharging tire sealant or pumping tire including: linear motion actuator which is fixed with the compressor body.

### TECHNICAL FIELD

The invention relates to the field of repairing tire used in automobiles, trucks, bicycles and other similar vehicles, more specifically relates to a kind of device for discharging tire sealant or pumping air into tire for a sealing and inflating use.

### BACKGROUND

Automobiles, trucks, bicycles and other similar vehicles are supported by toroidal wheel, which is surrounded by rubber tires filled with high-pressure air. During the life cycle of the wheel, one of the most common problems is the failure of the tires, which could be caused by various factors such as aging, creep of the rubber or just hit by some sharp objects. When the integrity of the tire is compromised, it cannot keep the air with high pressure anymore, the tire would become flat and cannot be used. This would be inconvenience or even dangerous for an automobile, truck, bicycle or other similar vehicle, especially during its driving process.

Some solutions have been made by previous researchers and inventors for decades, one of these solutions is providing a small, portable tire repair device that can be operated by an ordinary driver or passenger without professional skills or training to seal and inflate tires very easily. For instance, U.S. Pat. No. 6,283,174. U.S. Pat. No. 6,345,650 and U.S. Pat. No. 6,412,524

In all of the above references, existing technology are based on the compressor-sealant system. The compressor driven by electric motor provides compressed air flow with high speed and pressure, which could be used to pump air into a tire when the compressor is connected to the tire directly; if the sealant bottle which is used to contain sealant is inserted into the flow channel of the compressor-tire system, the air flow would be used to discharge tire sealant into a tire. In this situation, when the leakage speed of the compressed air contained inside the tire is less than the aeration speed of the air coming out from the compressor, the damaged tire could still keep an inflating state in order to getting more time for remedy.

In summary, a kind of suitable compressor would be one of the key points in this portable tire repair device, which should be able to generate enough power for inflating and sealing but is in small size for carrying and convenience for using.

In all of the above references and existing technology, the compressor that could generate enough power and high pressure with small volume are a piston pump structure. The piston of the compressor moves forward and backward, pushing the air existed in the cylinder into the tire through a pipe or a channel, and extracting fresh air from the outside into the cylinder. Compared to the other structures such as centrifugal compressor, membrane compressor and screw compressor, piston compressor could achieve a high pressure with a small size and simple structure, which is widely used in the prior art.

The movement of the piston compressor is based on the reciprocating motion of the piston. The general solution is a combination with a rotating electric motor and the piston through a typical crank-train structure. The rotating motor drives one or more gear reduction unit in order to reduce revolution and increase torque, then the final gear will drive a typical crank-train structure to transfer the rotation motion to reciprocating motion.

According to the working principle, it is obviously that the displacement of the piston movement is twice as long as the crank, which is one of the most significant parameters in compressor dynamic property. In a standard air cylinder system, the moving displacement multiply by the area of cross-section is equal to the swept volume, larger displacement means more compressed air is pumped into a tire during one period of motion, which means that with less numbers of motion period the tire could be inflated to a high pressure. Reduce the working cycle is helpful for reduce leakage and loss, enhance efficiency, extend working life. But in this case, a long crank would be needed and this results in a large compressor, which is unpractical in some dimension limited situations.

Furthermore, the crank-train mechanism will bring some other problems. When the connecting rod drives the piston moving forward and backward, an advancing angle between pushing force and moving track exists, the constraint forces is negligible and not essential when the angle is small, but with the angle increasing, the constraint force will be more significant and bring lots of adverse influences such as vibration and friction to the mechanical system. According to the analysis, even if the size of the rotation crank could be increased, the performance of the compressor will be no significant difference if the distance of the rod did not increase, which will go against the target of miniaturization.

To solve these problems, the mechanism structure should be re-designed. The limitation of the crank-train structure is an intrinsic problem, so a new alternative solution should be substituted for the original crank-train design. With the above analysis in view, it is an object of the present invention to create a piston compressor that with a large moving distance of piston and high transmission efficiency when the motor drove the piston.

### SUMMARY OF INVENTION

This invention is about a new compressor mechanism for discharging tire sealant or pumping air into tire for a sealing and inflating use. The mechanism has a minimum system which may comprise: power source, such as electric motor; power transmission components; compression unit, such as piston-cylinder system, and other parts of a device.

Optionally, when discuss with the detail structure of this device, power transmission components could have different forms such as gear set driven, gear pin driven or motor driven directly. For the same reason, the compression mechanism could also have different structures such as an independent cylinder or an integrated cylinder together with housing or frame.

The advantage of this kind of device is the ability to overcome the limitation of the advancing angle mentioned previously, which means a much longer cylinder than ever before could be launched without increasing the dimension of the compressor (the main contribution is from the flywheel and crank). This characteristic could help the compress mechanism to get over much performance bottleneck such as the barrier of efficiency caused by the compression stroke.

In one embodiment of the present application, it is provided a compressor for discharging tire sealant or pumping tire including: a body having an inlet for introducing the tire sealant or air and outlet for discharging the tire sealant; an electric motor which is fixed within body; a piston for compressing the tire sealant or air; a drive mechanism for transferring the output of the electrical motor into reciprocation movement of the piston, the drive mechanism includes a drive rod having bidirectional thread.

In another embodiment of the present application, a drive gear is mounted on an output shaft of the electric motor, a duplicate gear is provided to engage with the drive gear and the drive rod.

In another embodiment of the present application, the drive mechanism further includes a mating gear fixed to the drive rod, the mating gear is couple with the top of the duplicate gear the mating gear and the drive rod are planted to a platform, which is attached to the body and limits the axial drifting of mating gear and the drive rod, the axial rotation of mating gear and the drive rod is free.

In another embodiment of the present application, linear guide rails are provided in the body for guiding the platform, such that the platform can move forward and backward in a specific space while the mating gear is always engaged with the duplicate gear.

In another embodiment of the present application, the compressor further comprises a guide bar engaging with the drive rod, the guide bar moves along the thread of the drive rod, the guide bar is fixed on a support, the support is rotatable with respect to the body.

In another embodiment of the present application, wherein the guide bar and the drive rod form a straight screw drive mechanism, the bidirectional threads includes right hand thread and left hand thread, when the drive rod is rotating in clockwise direction from the vertical view, when the guide bar is under the right hand thread, it rises up to the top of the drive rod relatively and the drive rod is moving backward; when the guide bar arrived at the top of the drive rod, it separates itself from the right hand thread and go into the orbit of the left hand thread; when the drive rod is still rotating in clockwise direction from the vertical view, the guide bar drops down to the bottom of the drive rod relatively and the drive rod is moving forward; when the guide bar arrived at the bottom of the drive rod, it separates itself from the left hand thread and go into the orbit of the right hand thread, the cycle of this four process transmits the rotating motion of the drive rod in one direction to the reciprocating motion of the drive rod.

In another embodiment of the present application, the piston is connected with the drive rod, which moves forward and backward with the drive rod simultaneously.

In another embodiment of the present application, the compressor includes: thrust bearing and which are installed on the upper surface and bottom surface of the piston.

### BRIEF DESCRIPTION OF THE DRAWINGS

FIGS. 1a-1m shows the different forms of the new compressor mechanism of the invention, in which FIGS. 1(a) -1(b) show a structure with screw, independent cylinder and gear unit, FIGS. 1(c) and 1(d) show a structure with screw, gear unit and integrated cylinder, FIGS. 1(e) and 1(f) show a structure with screw, independent cylinder without gear unit, FIGS. 1(g) and 1(h) show a structure with screw and integrated cylinder without gear unit, FIGS. 1(i) and 1(j) show a structure with independent cylinder without screw and gear unit, and FIGS. 1(1) and 1(m) show a structure with integrated cylinder, without screw and gear unit.

FIGS. 2.1-2.5 are schematically illustrated views of the compression unit in example 1.

FIGS. 3.1-3.3 are schematically illustrated views of the compressor in example 2.

FIGS. 4.1-4.3 are schematically illustrated views of the compression unit in example 3.

FIGS. 5.1-5.3 are schematically illustrated views of the compression unit in example 4.

FIGS. 6.1-6.4 are schematically illustrated views of the compression unit in example 5.

FIGS. 7.1-7.3 are schematically illustrated views of the compression unit in example 6.

FIGS. 8.1-8.2 are schematically illustrated views of the compression unit in example 7.

### DETAILED DESCRIPTION

### Motor Source

The motor source in this invention represents for the electric motor, which uses electrical energy to produce mechanical energy, usually through the interaction of magnetic fields and current-carrying conductors. The motor is the power source of the compressor, which could generate the energy to compress the air and pump it into a tire.

There are two major forms of electric motor, i.e. rotational motor and linear motor. In contrast to the circular motion of a rotational motor, linear motor could create motion in a straight line, the motor shaft could move forward and backward. Although it is not that common, but linear motor can be also found in machine tools, industrial machinery and computer peripherals such as valves, dampers, disk drives and printers where linear motion is required.

In this invention, without specifically notice, the word “motor” represent the rotational motor. The second motor should be described as linear motion actuator or linear motor.

### Gear Unit

In this invention the gear unit represent for small size gear reduction unit. The load applied on the cylinder-piston will increase with the pressure, the motor will overload soon when the tire is pressurizing if it connected to the mechanism directly. The gear reduction unit could reduce the rotating speed of the rotor and increase the output torque.

In this invention the gear unit is an optional structure. When the torque of the motor is large enough, which means very expensive, the gear unit is dispensable. When the linear motor is used in the compressor, the gear unit could also be eliminated.

### Transformation System

In this invention the transformation system means that this mechanism could transfer the rotating motion of the rotor to the reciprocate motion to driving the piston. In general situation the screw mechanism could achieve the one way motion, for the movement including forward and backward without changing the rotating direction, a specific screw will be used in this invention. In this invention the transformation system is an optional structure. When the linear motor is used in the compressor, the transformation system could also be eliminated.

### Compression Mechanism

In this invention the compression mechanism is the traditional piston-cylinder mechanical system. The principle of this system is to generate pressure by compressing the gas inside the cylinder, when the inner pressure reaches the threshold value, the gas would be released out of the cylinder and pumped into the tire. This compression uses pistons driven by a crank to deliver air from the environment at high pressure.

The intake gas enters the suction manifold, then flows into the compression cylinder where it gets compressed by a piston driven in a reciprocating motion via a crank, and then discharged. The cylinders could be manufactured in the body of the compressor for shrinking the size.

### EXAMPLE

With different combination modes, the mechanism of compressor could have different forms. In this invention some forms will be described and distinguished. The following table shows these different combination ways

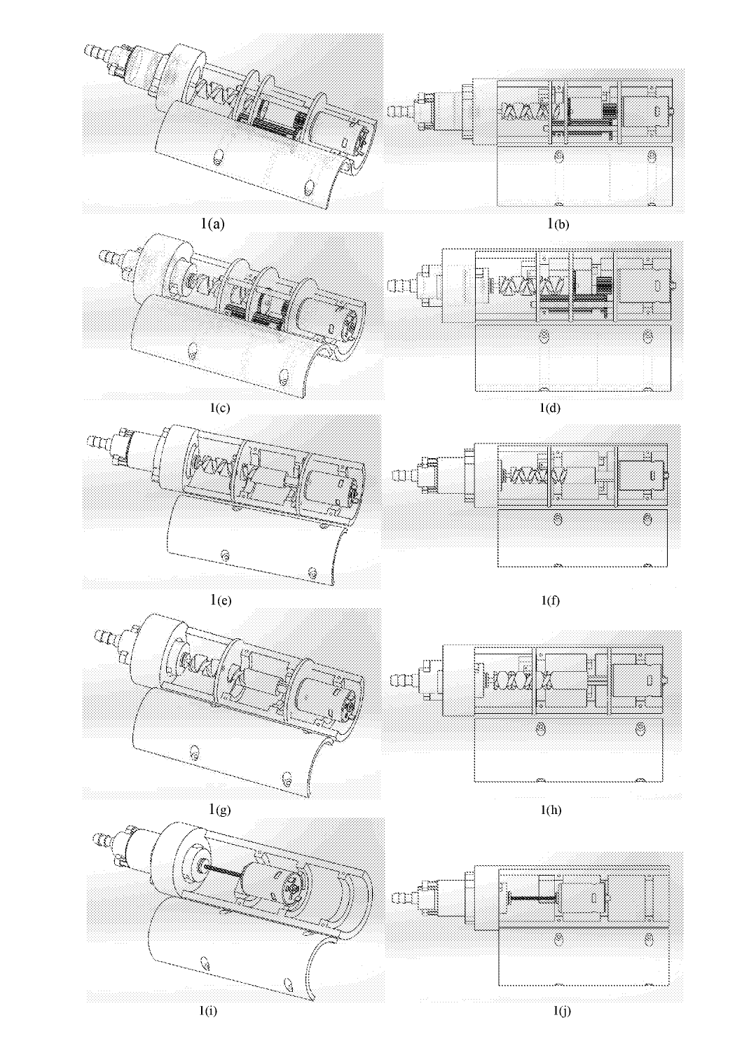

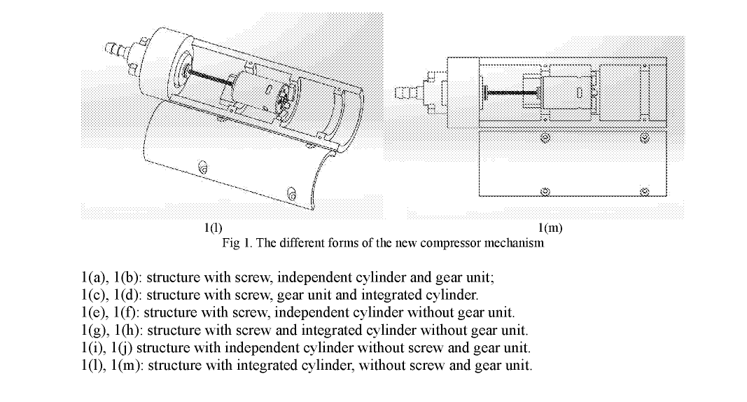

FIGS. 1(a) -1(b) show a structure with screw, independent cylinder and gear unit, FIGS. 1(c) and 1(d) show a structure with screw, gear unit and integrated cylinder, FIGS. 1(e) and 1(f) show a structure with screw, independent cylinder without gear unit, FIGS. 1(g) and 1(h) show a structure with screw and integrated cylinder without gear unit, FIGS. 1(i) and 1(j) show a structure with independent cylinder without screw and gear unit, and FIGS. 1(l) and 1(m) show a structure with integrated cylinder, without screw and gear unit. More details of the embodiments will be described in the below.

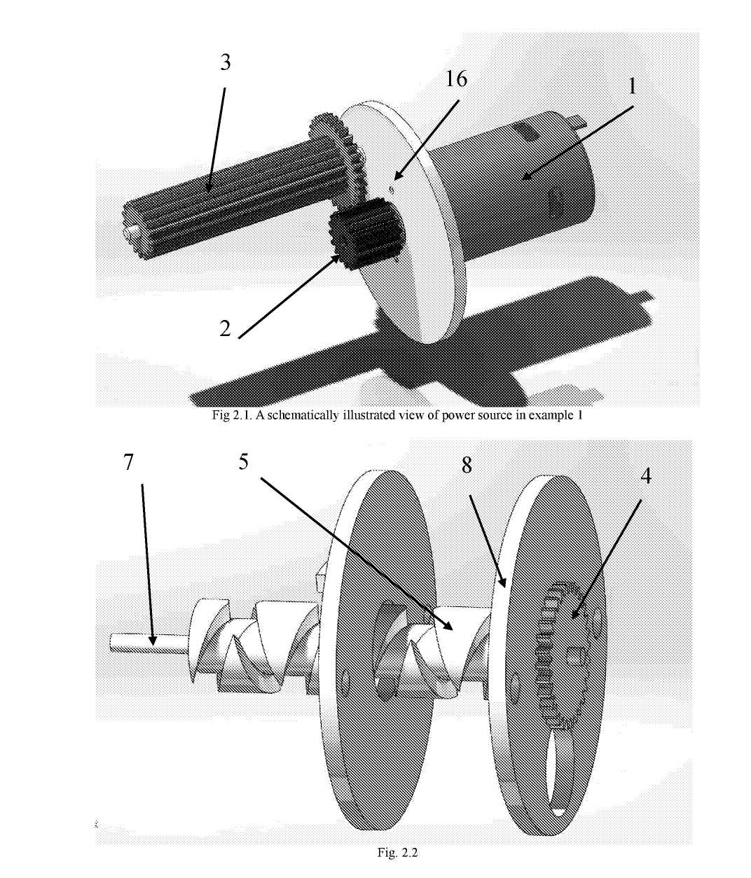

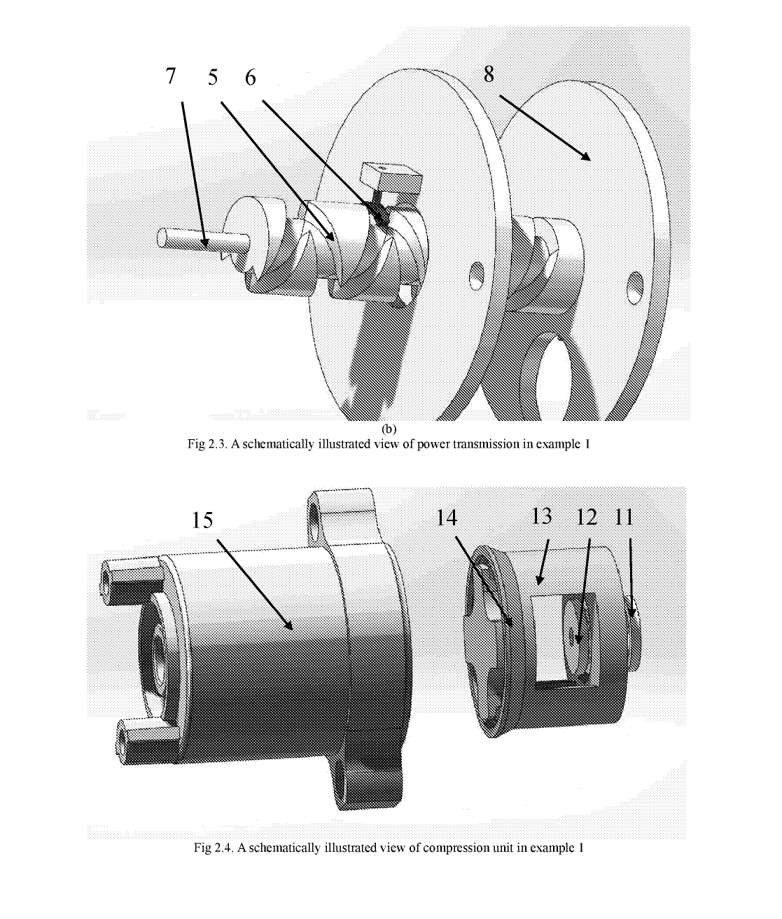

### Example 1: FIGS. 2.1-2.5

Example 1 is a device for injecting liquid sealant into a punctured pneumatic tire and then supplying compressed air into the pneumatic tire to raise internal pressure of the pneumatic tire, the device comprising: a power source including electric motor and gear transmission system which could generate mechanical energy and transfer it to power the transformation part; a power transformation system including mating gear, special—shaped screw, rotated guide-bar and piston rod which could transfer the rotatory motion of the gear to reciprocating motion of the piston rod; a compression unit including piston, piston ring and independent cylinder, which could pump the air out of the exit with pressure and speed.

FIG. 2.1 shows a schematically illustrated view of: power source, including electric motor 1, a pair of gears 2 and 3, which could generate the power in rotation form and transfer it to the power transformation part. The electric motor 1, the pair of gears 2 and 3 are placed on the platform 16.

FIGS. 2.2-2.3 shows a schematically illustrated view of: power transmission, including a mating gear 4, a drive rod 5, a guide-bar 6 and a piston rod 7, which could transfer the rotatory motion of the motor to reciprocating motion of the piston rod.

The guide bar 6 and the drive rod 5 form a straight screw drive mechanism. The drive rod 5 is provided with bi-directional threads. The bidirectional threads includes right hand thread and left hand thread. The right hand thread and the left hand thread intersect each other along the drive rod, and merge together at the top of the drive rod 5 and at the bottom of the drive rod 5. When the drive rod 5 is rotating in clockwise direction viewing from the top of the drive rod, when the guide bar 6 is under the right hand thread, the guide bar will rise to the top of the drive rod 5 and the drive rod 5 is accordingly moving backward; when the guide bar 6 arrived at the top of the drive rod 5, it separates itself from the right hand thread and go into the orbit of the left hand thread. When the drive rod 5 is still rotating in clockwise direction from the vertical view, the guide bar 6 drops down to the bottom of the drive rod 5 and the drive rod 5 is accordingly moving forward. When the guide bar 6 arrived at the bottom of the drive rod 5, it separates itself from the left hand thread and goes into the orbit of the right hand thread. In this way, the cycle of these four process transmits the rotating motion of the drive rod 5 in one direction to the reciprocating motion of the drive rod 5. Therefore, it can be appreciated that, if the guide bar 6 is fixed within the housing of the compressor, the continual rotation of the drive rod 5 will lead to a reciprocating motion of the drive rod 5.

The piston rod 7 is mounted to the drive rod 5 so that it will do a reciprocating movement together with the drive rod 5. One skilled in the art would understand that the piston rod 7 can be integrated with the drive rod 5, or the piston rod 7 can be mounted to the drive rod 5 through bearing so that the piston rod 7 can be rotated with respect to the drive rod 5. For example, a thrust bearing can be provided at the end of the drive rod 5. The piston rod 7 is mounted to the thrust bearing.

FIG. 2.4 shows a schematically illustrated view of: compress mechanism, including thrust bearing 11 and 12, piston 13, piston ring 14 and cylinder 15, which compress mechanism could pump the air out of the exit with pressure and speed. The piston rod 7 can be installed in the thrust bearing 11 and 12, while the piston 13 is mounted in the cylinder 15. With this arrangement, the piston 13 will be driven by the piston rod 7 to reciprocate within the cylinder 15 so that the air within the cylinder 15 will be compressed in each stroke. As it would be clear to one skilled in the art, the cylinder 15 will be provided with air inlet and air outlet, which are not shown in the FIG. 2.4.

FIG. 2.5 shows a schematically illustrated view of whole compressor in example 1. The guide bar 6 is engaged within the bidirectional threads of the drive rod 5 and can move along the threads. A support 10 is provided so that the guide bar 6 can be mounted thereon for example through an arm portion. The support 10 can be fixed to the body of the compressor. A through hole is provided on the support 10 so that the drive rod 5 can freely pass therethrough. In this connection, if the guide bar 6 moves along the thread of the drive rod 5, relative movement will occur between the support 10 and the drive rod 5.

The mating gear 4 is fixed to the drive rod 5 and coupled with the gear 3. In one embodiment, the mating gear 4 and the drive rod 5 are planted to a platform 8, e.g. by a bearing (not shown). The platform 8 is coupled to the body and limits the axial drifting of mating gear 4 and the drive rod 5 with respect to the platform 8. It can be appreciated that the mating gear 4 and the drive rod 5 can freely rotate with respect to the platform 8. With this arrangement, the motor 1 will drive the drive rod 5 to rotate. As shown in FIGS. 2.3 and 2.5, a through hole is provided in the platform 8 so that the gear 3 can extend therethrough.

Linear guide rails 9 can be provided in the body for guiding the platform 8, such that the platform 8 can move forward and backward along the body, and the mating gear 4 will axially displace with respect to the gear 3 while the mating gear 4 is always engaged with the gear 3. Preferably, the length of the gear 3 corresponds to the length of the bi-directional thread of the drive rod 5.

Once the motor 1 is rotated, it will drive the mating gear 4 and the drive rod 5 through the gear 3. Relative movement will occur between the guide bar 6 and the drive rod 5. Since the guide bar 6 is fixed, the drive rod 5 together with the platform 8 will displace in the axial direction, which in turn will displace the piston 13 within the cylinder 15.

It can be understood that, in the above configuration, when the guide bar 6 is at the top of the bi-directional thread, the piston 13 locates at the bottom of the cylinder 15, i.e. at its lower dead point. With continual rotation of the motor 1, the guide bar 6 will engage with the left hand thread and the drive rod 5 will move forward, i.e. from right to left in FIG. 2.5. Thus the air within the cylinder 15 will be compressed by the piston 13 as the piston 13 moves forward. When the guide bar 6 reaches the bottom of the bi-directional thread, the piston 13 reaches its upper dead point. The air is compressed and will be discharged. Then the guide bar 6 will shift from the left hand thread to the right hand thread, and the piston 13 will move toward its lower dead point. Fresh air will be sucked into the cylinder during this movement. The cycle will continue as the motor keeps rotating in one direction.

Although in the above embodiment the platform 8 is movable and the support 10 is fixed with respect to the body of the compressor, it can be understood that reversed configuration is also possible. That is, the platform 8 can be fixed and the support 10 is movable along the axial direction of the compressor. In this case, a circular track can be provided on the support 10 to engage with the guide bar 6 so that the guide bar 6 can perform circular movement around the drive rod 5. The piston rod 7 is fixed to the support 10 so that the piston will be driven by the movement of the support 10. Linear guide rails can be provided in the body for guiding the support 10. Alternatively, the guide bar 6 is fixed to the support 10 and the support 10 rotatably supported with the body, for example, the support is movably installed in an annular groove in the body.

Other variations can be come out with the teaching of the present application without falling out the scope of the present application.

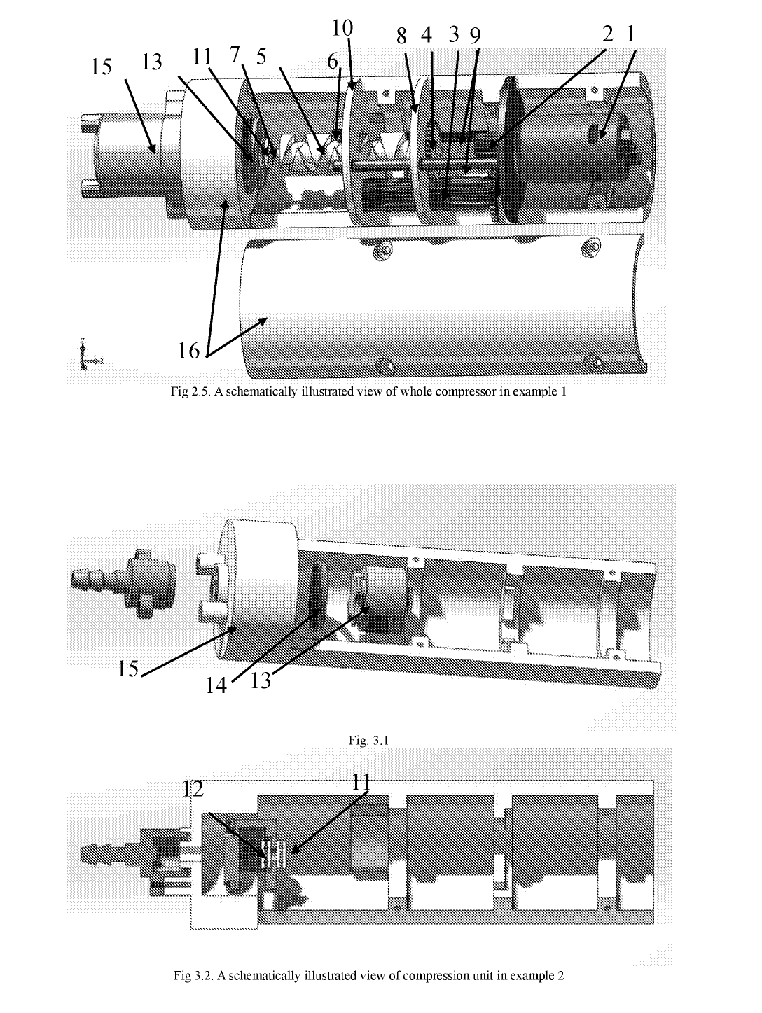

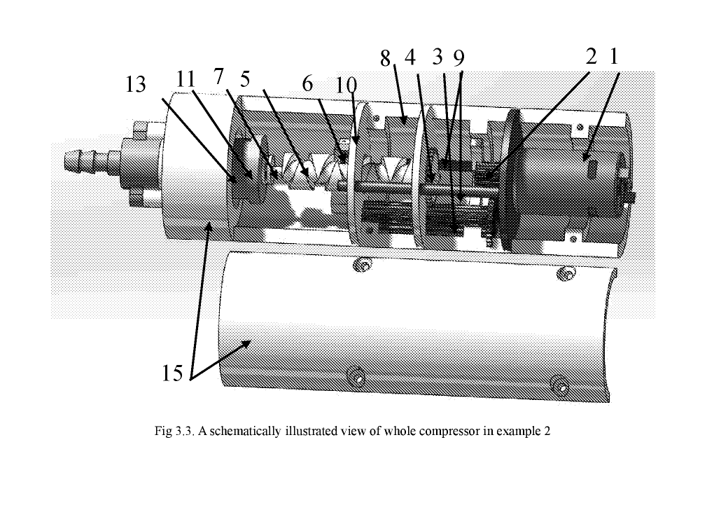

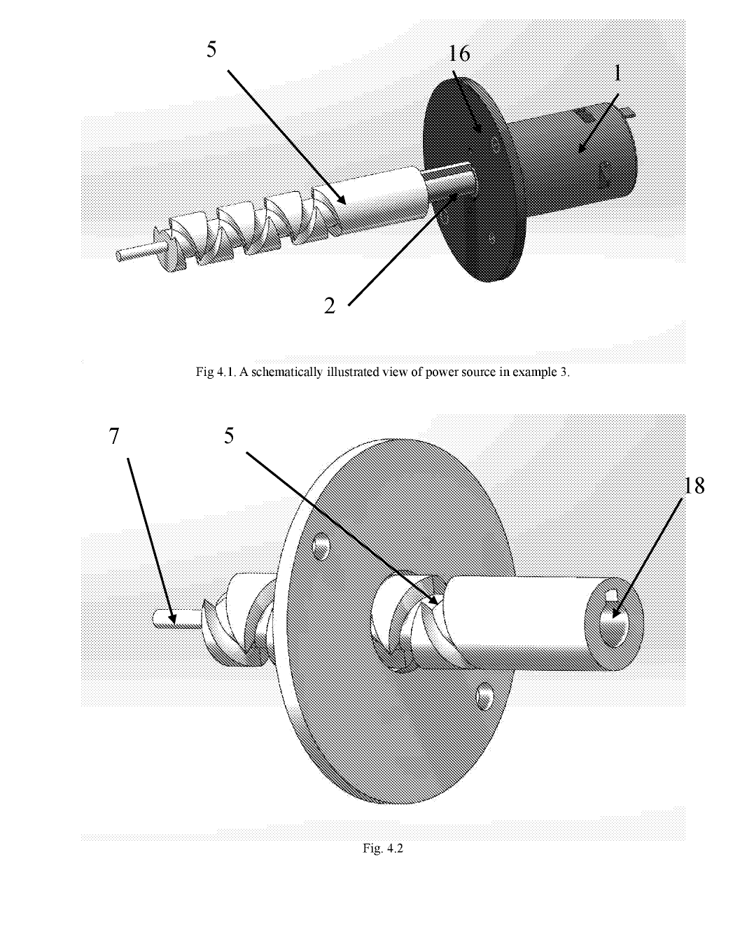

### Example 2: FIGS. 3.1-3.3

Example 2 is a device for injecting liquid sealant into a punctured pneumatic tire and then supplying compressed air into the pneumatic tire to raise internal pressure of the pneumatic tire, the device comprising: a power source including electric motor and gear transmission system which could generate mechanical energy and transfer it to power transformation part; a power transformation system including mating gear, -bi-directional thread screw, rotated guide-bar and piston rod which could transfer the rotatory motion of the gear to reciprocating motion of the piston rod; a compression unit including piston, piston ring and cylinder, which could pump the air out of the exit with pressure and speed.

The difference between example 2 and example 1 is that the cylinder structure in example 2 is in integrated to the compressor body.

FIGS. 3.1-3.3 shows a schematically illustrated view of: compress mechanism, including thrust bearing 11 and 12, piston 13, piston ring 14 and cylinder 15, which could pump the air out of the exit with pressure and speed. The cylinder 15 is integrated with the body of the compressor so that it will reduce the components of the compressor. The other configurations are similar to that of the example 1.

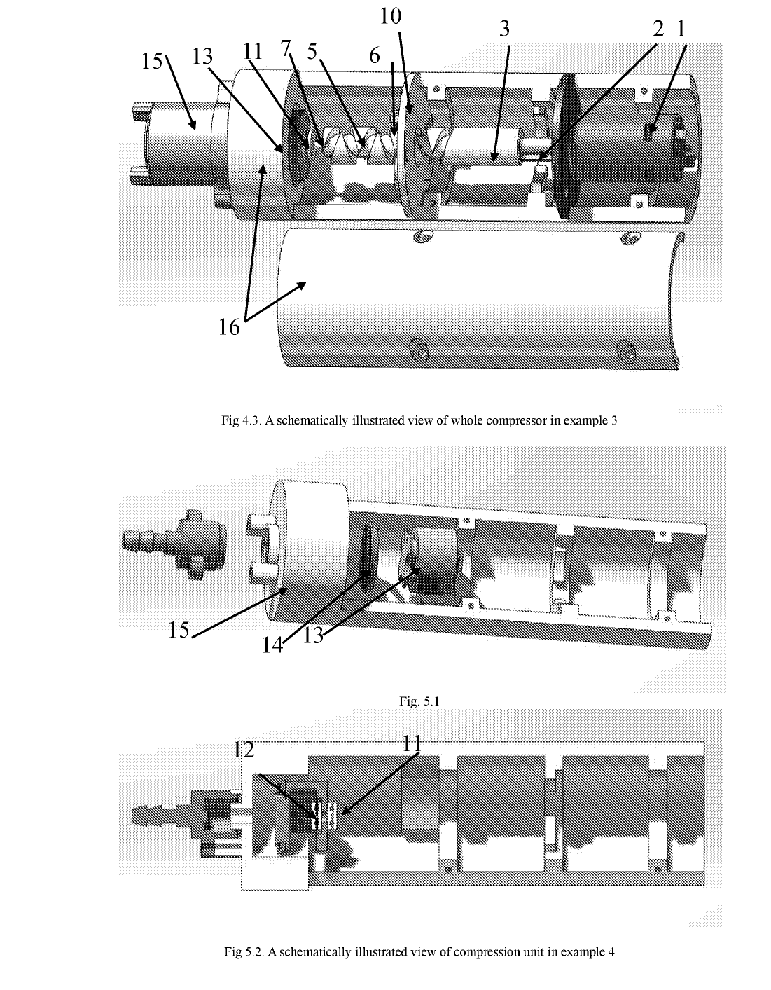

### Example 3: FIGS. 4.1-4.3

Example 3 is a device for injecting liquid sealant into a punctured pneumatic tire and then supplying compressed air into the pneumatic tire to raise internal pressure of the pneumatic tire, the device comprising: a power source including electric motor and gear pin transmission system which could generate mechanical energy and transfer it to power transformation part; a power transformation system including gear pin, special—shaped screw, rotated guide-bar and piston rod which could transfer the rotatory motion of the gear to reciprocating motion of the piston rod; a compression unit including piston, piston ring and independent cylinder, which could pump the air out of the exit with pressure and speed.

The difference between example 4 and example 1 is that the motor in example 4 is used to drive the screw directly without gearbox, which could simplify the mechanism but bring greater demands for the motor performance.

FIG. 4.1 shows a schematically illustrated view of: power source, including electric motor 1, which could generate the power in rotation form, a gear pin 2 having a protrusion, which transfers the rotation to power transformation part. The electric motor 1, the gear pin 2 are placed on the platform 16, the drive rod 5 is provided with an inner recess 18 (see FIG. 4.2) to mate with the gear pin 2 so that the rotation of the motor 1 will drive the drive rod 5. Therefore, it is not necessary to provide gears between the gear pin 2 and the drive rod screw 5.

Similar to example 1, the relative movement between the drive rod 5 and the support 10 can be achieved by axial movement of the drive rod or the axial movement of the support 10.

If the support 10 is fixed and the drive rod 5 performs reciprocating axial movement, the length of the inner recess 18 and the length of the gear pin 2 should be long enough so that the inner recess 18 can keep engaging with the gear pin 2. Moreover, the diameter of the inner recess 18 should be a little larger than the diameter of the gear pin 2 to allow an axial displacement therebetween. As shown in FIGS. 4.1 and 4.2, the recess is provided with a key and the gear pin 2 is provided a corresponding protrusion so that rotational movement between the gear pin 2 and the drive rod 5 is not allowable.

If the support 10 performs reciprocating axial movement, the drive rod 5 can be fixed to the gear pin 2. In this case, a circular track can be provided on the support 10 to engage with the guide bar 6 so that the guide bar 6 can perform circular movement around the drive rod 5. The piston rod 7 is fixed to the support 10 so that the piston will be driven by the axial movement of the support 10. Linear guide rails can be provided in the body for guiding the support 10,

The other configurations may be similar to that of the example 1 and example 2.

FIG. 4.3 shows a schematically illustrated view of: compress mechanism, including thrust bearing 11 and 12, piston 13, piston ring 14 and cylinder 15, which could pump the air out of the exit with pressure and speed.

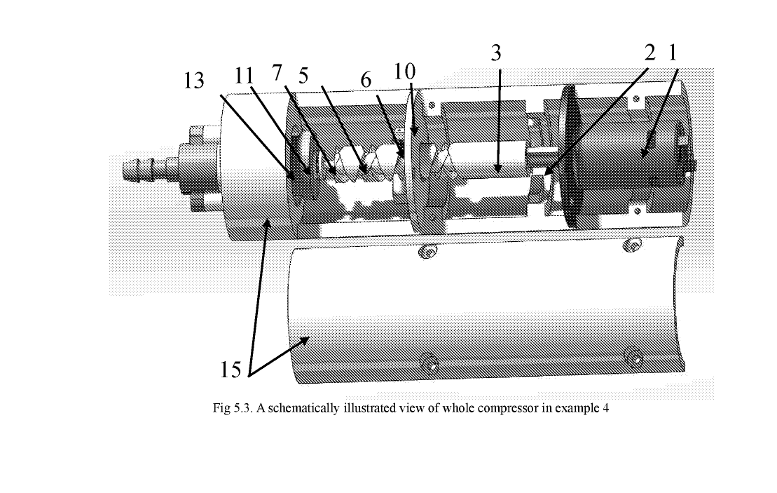

### Example 4: FIGS. 5.1-5.3

An invention of example 5 is a device for injecting liquid sealant into a punctured pneumatic tire and then supplying compressed air into the pneumatic tire to raise internal pressure of the pneumatic tire, the device comprising: a power source including electric motor and gear pin transmission system which could generate mechanical energy and transfer it to power transformation part; a power transformation system including gear pin, bi-directional thread screw, rotated guide-bar and piston rod which could transfer the rotatory motion of the gear to reciprocating motion of the piston rod; a compression unit including piston, piston ring and independent cylinder, which could pump the air out of the exit with pressure and speed.

The different between example 4 and example 3 is that the cylinder structure in example 4 is in integrated to the compressor body.

FIG. 5.1-5.3 shows a schematically illustrated view of: compress mechanism, including thrust bearing 11 and 12, piston 13, piston ring 14 and cylinder 15, which could pump the air out of the exit with pressure and speed. The cylinder 15 is integrated with the body of the compressor so that it will reduce the components of the compressor. The other configurations are similar to that of the example 1.

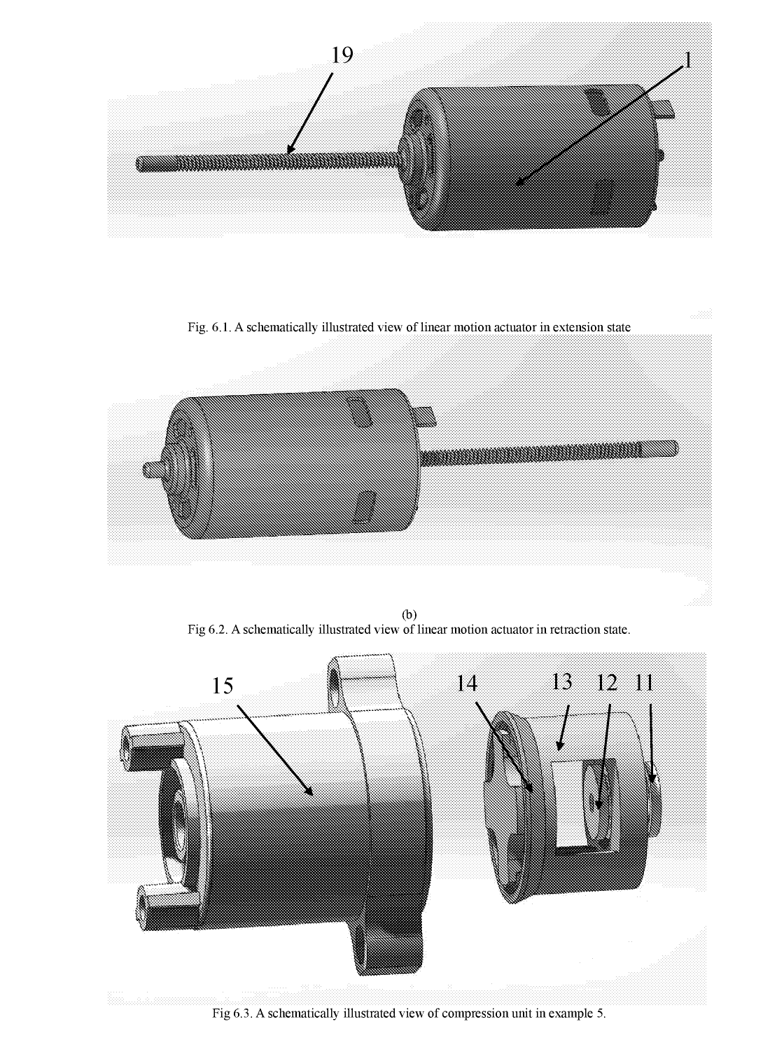

### Example 5: FIGS. 6.1-6.4

An invention of example 6 is a device for injecting liquid sealant into a punctured pneumatic tire and then supplying compressed air into the pneumatic tire to raise internal pressure of the pneumatic tire, the device comprising: a power source including linear motion actuator which could generate mechanical energy; a compression unit including piston, piston ring and independent cylinder, which could pump the air out of the exit with pressure and speed.

FIGS. 6.1-6.2 shows a schematically illustrated view of linear motion actuator which could generate the mechanical energy in reciprocating form directly, FIG. 6.1 for the extension state and FIG. 6.2 for the retraction state. In this situation the piston could be connected to the linear motion actuator directly and achieve the reciprocating moving without any complicated mechanism as described before.

FIG. 6.3-6.4 shows a schematically illustrated view of: compress mechanism, including thrust bearing 11 and 12, piston 13, piston ring 14 and cylinder 15, which could pump the air out of the exit with pressure and speed. The linear motion actuator, e.g. linear motion motor 1 can be fixed to the body 16 of the compressor. The rotation shaft 19 will displace along the axial direction of the compressor. By controlling the linear motion actuator, reciprocating movement of the rotation shaft 19 can be achieved. Thus, air can be compressed in the cylinder 15 and then discharged to a tire.

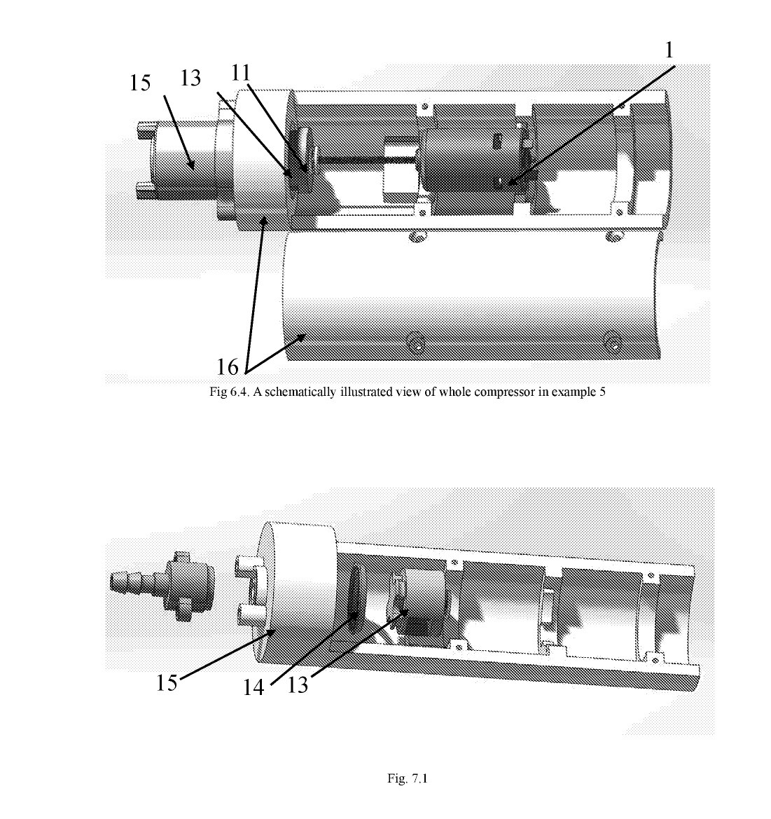

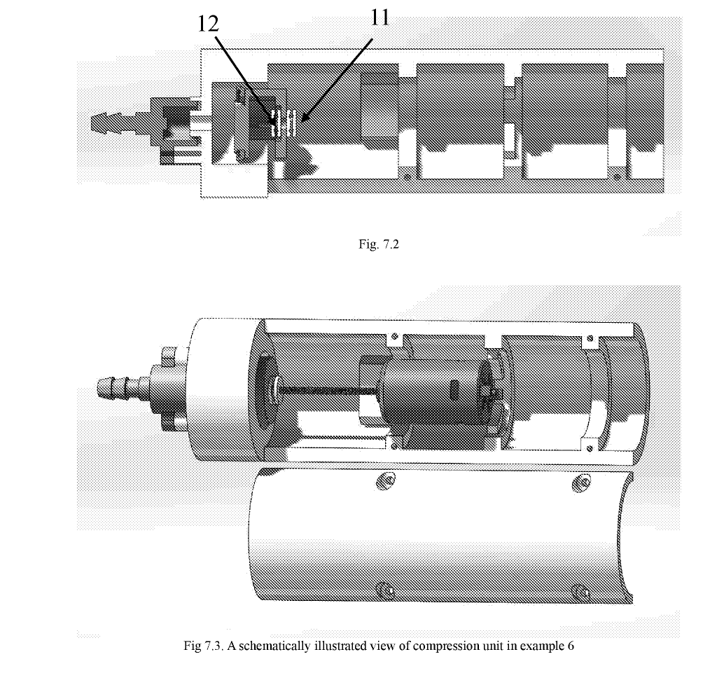

### Example 6: FIGS. 7.1-7.3

Example 6 is a device for injecting liquid sealant into a punctured pneumatic tire and then supplying compressed air into the pneumatic tire to raise internal pressure of the pneumatic tire, the device comprising: a power source including linear motion actuator which could generate mechanical energy, a compression unit including piston, piston ring and independent cylinder, which could pump the air out of the exit with pressure and speed.

The different between example 6 and example 5 is that the cylinder structure in example 6 is in integrated to the compressor body.

FIG. 7.1-7.3 shows a schematically illustrated view of: compress mechanism, including thrust bearing 11 and 12, piston 13, piston ring 14 and cylinder 15, which could pump the air out of the exit with pressure and speed. The cylinder 15 is integrated with the body of the compressor so that it will reduce the components of the compressor. The other configurations are similar to that of the example 1.

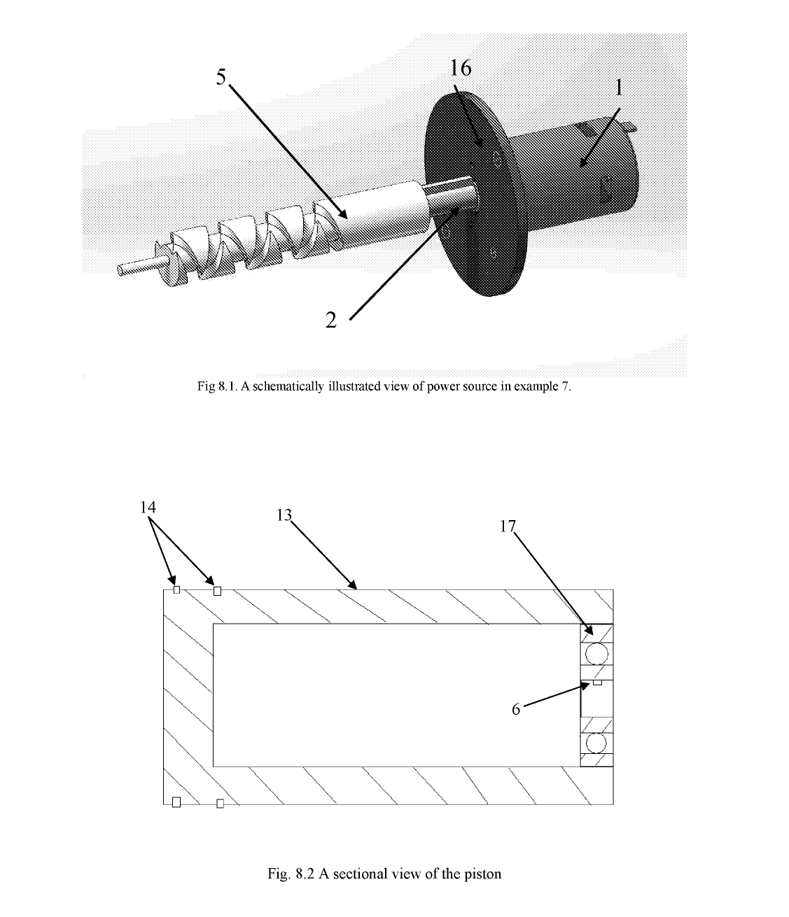

### Example 7: FIGS. 8.1-8.2

FIGS. 8.1-8.2 show a further embodiment of the present application. In this embodiment, FIG. 8.1 shows a schematically illustrated view of: power source, including electric motor 1, which could generate the power in rotation form, a gear pin 2 having a protrusion, which transfers the rotation to power transformation part. The electric motor 1, the gear pin 2 are placed on the platform 16, the drive rod 5 is provided with an inner recess to mate with the gear pin 2 so that the rotation of the motor 1 will drive the drive rod 5 to rotate. It is preferred that the drive rod 5 is fixed to the gear pin 2. Therefore, it is not necessary to provide gears between the gear pin 2 and the drive rod 5.

FIG. 8.2 is a sectional view of the piston 13 which cooperates with the cylinder (not shown). The piston 13 is provided with one or two piston ring 14. One end of the piston 13 is opened while the other end of the piston 13 is closed. A bearing 17 is mounted at the opened end of the piston 13, for example by threads or other methods known in the art. The guide-bar 6 is fixed on the inner ring of the bearing 17. The diameter of the drive rod 5 is less than the diameter of the inner ring of the bearing 17 so that the drive rod 5 can pass through the bearing 17 while the guide-bar 6 mates with the bidirectional thread of the drive rod 5. Therefore, with the rotation of the drive rod 5, the guide bar 6 will move along the bidirectional thread of the drive rod 5 as described above. Thus reciprocation of the piston 13 can be achieved. In other words, the piston 13 will reciprocate within the cylinder 15 to compress the air therein.

One skilled in the art would understand that the length of the piston should be long enough to accommodate the drive rod 5.

While the above detailed description has shown, described, and pointed out novel features as applied to various embodiments, it will be understood that various omissions, substitutions, and changes in the form and details of the device or process illustrated may be made without departing from the spirit of the disclosure. Additionally, the various features and processes described above may be used independently of one another, or may be combined in various ways. All possible combinations and subcombinations are intended to fall within the scope of this disclosure. Many of the embodiments described above include similar components, and as such, these similar components can be interchanged in different embodiments.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein.

1. A compressor for discharging tire sealant or for pumping tires including:
a body having an inlet for introducing the tire sealant or air and an outlet for discharging the tire sealant;
an electric motor which is fixed within the body;
a piston for compressing the tire sealant or air in a cylinder;
a drive mechanism for transferring the output of the electrical motor into reciprocation movement of the piston,
the drive mechanism includes a drive rod having bidirectional thread.

2. A compressor according to claim 1, wherein a drive gear is mounted on an output shaft of the electric motor, a duplicate gear is provided to engage with the drive gear and the drive rod.

3. A compressor according to claim 2 wherein the drive mechanism further includes a mating gear fixed to the drive rod, the mating gear is coupled with the top of the duplicate gear the mating gear and the drive rod are planted to a platform, which is attached to the body and limits the axial drifting of mating gear and the drive rod, the axial rotation of mating gear and the drive rod is free.

4. A compressor according to claim 3, wherein linear guide rails are provided in the body for guiding the platform, such that the platform can move forward and backward in a specific space while the mating gear is always engaged with the duplicate gear.

5. A compressor according to claim 4, further comprising a guide bar engaging with the drive rod, the guide bar moves along the thread of the drive rod, the guide bar is fixed on a support.

6. A compressor according to claim 5, wherein the guide bar and the drive rod form a straight screw drive mechanism, the bidirectional threads thread includes a right hand thread and a left hand thread,
when the drive rod is rotating in a clockwise direction from a vertical view, when the guide bar is under the right hand thread, it rises up to the top of the drive rod relatively and the drive rod is moving backward;
when the guide bar arrives at the top of the drive rod, it separates itself from the right hand thread and goes into an orbit of the left hand thread;
when the drive rod is still rotating in a clockwise direction from the vertical view, the guide bar drops down to the bottom of the drive rod relatively and the drive rod is moving forward;
when the guide bar arrives at the bottom of the drive rod, it separates itself from the left hand thread and goes into an orbit of the right hand thread,
the cycle of these four processes transmits the rotating motion of the drive rod in one direction to the reciprocating motion of the drive rod.

7. A compressor according to claim 6, the piston is connected with the drive rod, which moves forward and backward with the drive rod simultaneously.

8. A compressor according to claim 3, including: thrust bearings which are installed on an upper surface and a bottom surface of the piston.

9. A compressor according to claim 8, wherein the piston and the thrust bearings are assembled as a component, such that the piston could move forward and backward together with the drive rod but does not rotate with the drive rod.

10. A compressor according to claim 8, wherein a piston ring is fixed with the piston, the cylinder is fixed with the compressor body, the piston ring and cylinder form a piston compression structure in order to pump the air or sealant out of the cylinder.

11. A compressor according to claim 8, wherein a piston ring is fixed with the piston, the cylinder structure is integrated with the compressor body, the piston ring and compressor body form a piston compression structure in order to pump the air or sealant out of the compressor.

12. A compressor according to claim 1, wherein the electric motor has an output shaft with a key, the drive rod has a keyed recess mating with the output shaft such that the drive rod rotates with the output shaft and can be movable in an axial direction with respect to the output shaft.

13. A compressor according to claim 12, further comprising a guide bar engaging with the drive rod, the guide bar moves along the thread of the drive rod, the guide bar is fixed on a support, the support is rotatable with respect to the body.

14. A compressor according to claim 13, wherein the support is installed in an annular groove in the body.

15. A compressor according to claim 14, wherein the guide bar and the drive rod form a straight screw drive mechanism, the bidirectional thread includes a right hand thread and a left hand thread,
when the drive rod is rotating in a clockwise direction from a vertical view, when the guide bar is under the right hand thread, it rises up to the top of the drive rod relatively and the drive rod is moving backward;
when the guide bar arrives at the top of the drive rod, it separates itself from the right hand thread and goes into an orbit of the left hand thread;
when the drive rod is still rotating in a clockwise direction from the vertical view, the guide bar drops down to the bottom of the drive rod relatively and the drive rod is moving forward;
when the guide bar arrives at the bottom of the drive rod, it separates itself from the left hand thread and goes into an orbit of the right hand thread,
the cycle of these four processes transmits the rotating motion of the drive rod in one direction to the reciprocating motion of the drive rod.

16. A compressor according to claim 15, a wherein the piston is connected with the drive rod, which moves forward and backward with the drive rod simultaneously.

17. A compressor according to claim 16, including: thrust bearings which are installed on an upper surface and a bottom surface of the piston.

18. A compressor according to claim 17, wherein the piston and the thrust bearings are assembled as a component, such that the piston could move forward and backward together with the drive rod but does not rotate with the drive rod.

19. A compressor according to claim 18, wherein a piston ring is fixed with the piston, the cylinder is fixed with the compressor body, the piston ring and the cylinder form a piston compression structure in order to pump the air or sealant out of the cylinder.

20. A compressor according to claim 18, a piston ring is fixed with the piston, the cylinder structure is integrated with the compressor body, the piston ring and the compressor body form a piston compression structure in order to pump the air or sealant out of the compressor.

21. A compressor according to claim 5, wherein the guide bar has a length which enables the guide bar will move along one thread until the end of the one thread.

22. A compressor according to claim 1, wherein the piston is open at one end, which end is provided with a bearing having a guide bar on its inner ring, the drive rod passes through the inner ring so that the guide bar mates with the bidirectional thread of the drive rod.

23. A system for a compressor for discharging tire sealant or for pumping a tire including: a linear motion actuator which is fixed with a compressor body; an electric motor which is fixed within the compressor body; and a piston for compressing the tire sealant or air in a cylinder.

24. The system according to claim 23, including: a piston which is installed on one end of the linear motion actuator, and thrust bearings which are installed on an upper surface and a bottom surface of the piston.

25. The system according to claim 24, wherein a piston rod, the piston, and the thrust bearings are assembled as a component, such that the function that the piston could move forward and backward together with the piston rod but will not rotate with piston rod can be achieved.

26. The system according to claim 24, wherein a piston ring is fixed with the piston, a cylinder structure is integrated with the compressor body, the piston ring and the compressor body forms form a piston compression structure in order to pump the air out of the compressor.

27. The system according to claim 24, wherein a piston ring is fixed with the piston, a cylinder is fixed with the compressor body, the piston ring and the cylinder forms form a piston compression structure in order to pump the air out of the cylinder.
